(19) United States
(12) Patent Application Publication
(10) Pub. No.: US 2006/0262574 A1
(43) Pub. Date: Nov. 23, 2006

(54) DC high voltage to DC low voltage converter

(76) Inventor: David Kelly, Calgary (CA)

Correspondence Address: DIEDERIKS & WHITELAW, PLC, 12471 Dillingham Square, #301, Woodbridge, VA, 22192, US

(21) Appl. No.: 11/133,189

(22) Filed: May 20, 2005

(51) Int. Cl. H02M 3/335

(52) U.S. Cl. 363/17

(57) ABSTRACT

A high voltage DC to low voltage converter having a plurality of switches, connected in series, paired to form half bridges, inputs connected in series across a high voltage DC source, with outputs summed together using one or more primaries of one or more transformers, with one or more secondaries rectified and filtered to form an isolated DC output at a lower voltage. Each half bridge has an input voltage that is less than the overall input voltage.

### FIELD OF THE INVENTION

The present invention relates generally to power supplies and more particularly the conversion of a high voltage direct current (DC) to a lower voltage DC.

### BACKGROUND OF THE INVENTION

Conversion of high voltage DC to a lower voltage has become a problem with the advancement of a number of technologies. One is the continuing development of the Electrohydrodynamic or Electrokinetic Generator, where modern versions produce a high voltage DC output in the order of a few 10s of kV. Such a high voltage has few useful direct applications, and for that reason must be converted to a lower voltage which is more usable by current systems and devices.

Advancement in solid stage microwave amplifiers has necessitated the development of replacement modules for high voltage vacuum tube based microwave devices. The commercial requirement is for a drop-in replacement for the vacuum tube, which requires an added converter to change the high voltage previously used by the vacuum tube amplifier to a lower voltage required by the solid state replacement.

Another emerging market pertains to advances in energy storage in high voltage capacitors which may involve the need to efficiently convert a high voltage to a more usable lower voltage DC.

FIG. 1, taken from U.S. Pat. No. 3,022,430, Feb. 20, 1962, “Electrokinetic Generator” uses a rotating switch arrangement with a capacitor divider to convert high voltage DC to a lower voltage DC. A brief explanation follows; a rotating switch alternately connects capacitors 68 and 69 across capacitors, 52, 53, 54, 55, 56 and 57. The charge is transferred from these capacitors and stored on 68, 69, then applied to output capacitor 52. The output is thereby reduced in voltage from the original value applied across Vdc+70 and Vdc−58. The use of mechanical switches requires frequent maintenance and requires large capacitance values for the capacitors.

FIG. 2 shows part of another typical technology employed by the power industry for transmitting high voltage high power DC across large distances. The technical reference Dennis A. Woodford “HVDC Transmission” Manitoba HVDC Research Centre, 18 Mar. 1998 (27 pages), provides much more detail. Typical voltages are 500 kV, using 200 or more high voltage solid-state switches in series. These solid-state switches are slow and designed for very high levels of power, and are not suitable for use at the relatively lower power levels addressed by the current invention. In FIG. 2 which also describes the prior art, switches 101, 102, 103 are in series and pull the end of capacitor 107 to Vdc+150 when the SWITCH DRIVE 155 is in the first state shown by the table called SWITCH DRIVE 154. Alternately, as the process progresses along, the clock table switches 101, 102, 103 open and then 104, 105, 106 are closed and connect the end of capacitor 107 to Vdc−152. The resulting action of alternating the connections of capacitor 107 between Vdc+150 and Vdc−151 creates a square wave on the primary of transformer 108, which is then reduced in voltage and then rectified into a lower voltage DC V out+152 and V out−153. Alternately, (again referring to FIG. 2) the output of transformer 108 is filtered to make a clean AC waveform by removing rectifiers 109, 110 and replacing them with a suitable filter. The disadvantage of this technology is that for lower power operation the switch losses are large when the frequency of operation is increased. The very high losses encountered when operating at high frequency are undesirable from a cost of operation standpoint. Further, the potential benefits of operating at high frequency and smaller component size for transformer 108 and capacitors 107,111 are not possible with current methods. As well, the large number of switches stacked in series in the prior art requires special protection circuits (not shown in FIG. 2), to ensure that all switches share the voltage equally, increasing the cost of manufacture, and adding to device complexity.

The following patents are relevant styles of power converters but not all are designed specifically for high voltage DC-to-DC operation: U.S. Pat. No. 5,199,285, Jun. 2, 1992; “Solid State Power Transformer Circuit”; U.S. Pat. No. 5,666,278, Sep. 9, 1997, “High Voltage Inverter Utilizing Low Voltage Power Switches”; U.S. Pat. No. 5,943,229, Aug. 24, 1999, “Solid State Transformer”.

### SUMMARY OF THE INVENTION

It is an object of the present invention to obviate or mitigate at least one disadvantage of previous power converters.

In one aspect, the invention provides an improved method of converting a high voltage DC into low voltage DC. A plurality of (N) switches are connected in series to a high voltage DC source and operated as pairs to form a plurality of half bridges. The SWITCH DRIVE operates the switches using a predefined, controlled switching sequence. The SWITCH DRIVE operates using 100% duty such that only one switch belonging to a switch pair is ON for half the time (with the other being ON for the other half), and with the pattern alternating sequentially between the two switches in a pair. The SWITCH DRIVE circuit may be powered by a separate power source or alternately a special start-up run control circuit that operates from the high voltage input. The outputs of the switches are then connected to either a single or plural number of isolation transformers with a single or multiple primaries.

In one embodiment, each primary of the isolation transformer(s) will have one or more capacitor in series to block the flow of DC voltage. This preferred embodiment has at least one or a plurality of isolated secondaries that have the output rectified and filtered to provide the intended low voltage DC output.

Another preferred embodiment provides a well-regulated low voltage DC output. It consists of a plurality of (N) switches connected in series to a high voltage DC source and operated as pairs to form a plurality of half bridges. The switches are operated using a predefined, controlled switching sequence by a SWITCH DRIVE. The SWITCH DRIVE uses a variable switch ON time or duty, but only one switch belonging to a switch half bridge is ON at any time. For a portion of a cycle both switches are OFF and the pattern alternates sequentially between the two switches in a half bridge. The switch drive circuit may be powered by a separate power source or alternately a special start-up run control circuit that operates from the high voltage input. The outputs of the switches are then connected to either a single or plural number of isolation transformers with a single or multiple primaries. In an embodiment of this variant, each primary of the isolation transformer(s) will have one or more capacitor in series to block the flow of DC voltage. This embodiment has at least one isolated secondary that has the output rectified by diodes with the output of each diode feeding the input of one or more inductor(s). The output of this inductor is then connected to a capacitor to filter out any undesired ripple current. The resulting DC output may be then changed or regulated using feedback and a control circuit that alters the duty of the drive signals applied to the switches (and thus the ON time).

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 depicts a known method using mechanical rotary switch to perform the DC-to-DC conversion;

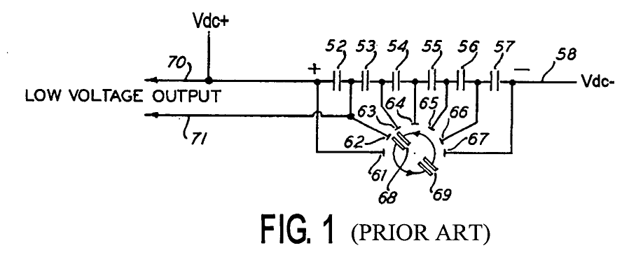

FIG. 2 depicts a known method showing current method of converting high voltage DC to lower voltage AC or DC;

FIG. 3 is a generalized schematic representation of a converter of the present invention;

FIG. 4 is a schematic representation showing another embodiment of the converter of the present invention;

FIG. 5 is a schematic representation showing another embodiment of the converter of the present invention; and

FIG. 6 is a schematic representation showing a variation of the convert of the present invention, providing a regulated output.

### DETAILED DESCRIPTION

Generally, the present invention provides a system and use of that system for converting high voltage DC into low voltage AC or low voltage DC, for a wide variety of applications.

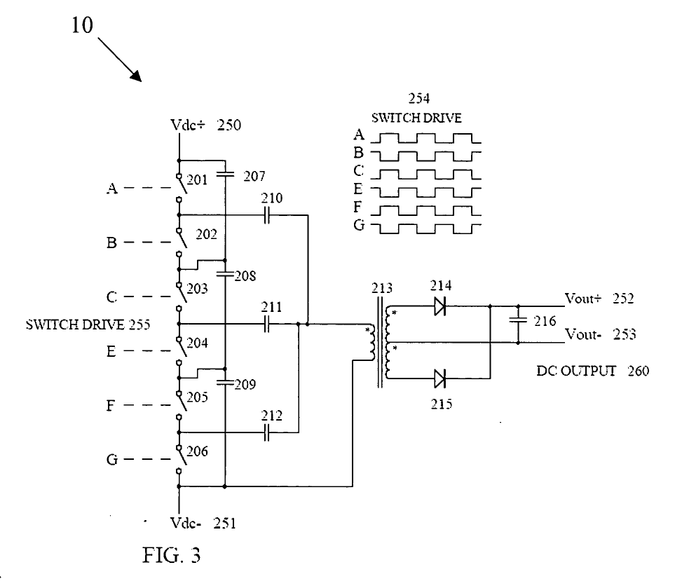

Referring generally to FIG. 3, a simple generic schematic of the converter 10, in accordance with the present invention is shown. Switches 201, 202 form a half bridge with switches 203, 204 forming another half bridge and switches 205 206 forming a third. All three half bridges are operated in the same manner, with switches 201, 203, 205 having the same waveforms shown in a SWITCH DRIVE 254 and the switches 202, 204 206 having similar switching waveforms. The depiction of three half bridges is merely an example of the number, N, of half bridges, and it is obvious to those skilled in the art that the number of half bridges may be increased or decreased as part of the overall design of the converter 10. The switches are shown as a generic representation of a switching device, which may be typically a solid-state device, preferably with a reverse diode across it. The capacitors 207, 208, 209 may reduce the ripple voltage and current that appears across the groups of half bridges. The Capacitors 210, 211, 212 are used to couple the AC waveform output of the switches to the primary of a transformer 213. The capacitors block the DC component present on the half bridge outputs from the primary of the transformer 213. The primary of the transformer 213 is shown connected to Vdc−251 by example, but it may alternatively be connected to any lead, of any of the appropriately sized capacitors 207, 208 or 209. The waveform outputs of all three half-bridge sets comprising switches 201, 202; 203, 204; 205, 206 share equally in the load and the voltages across capacitors 207, 208 and 209 during operation are nearly identical. When high voltage is applied across Vdc+250 and Vdc−251 then the output of these three half bridges is typically square wave and is reduced by the transformer 213 in amplitude as well as isolated from the primary high voltage as required. The secondary of the transformer 213 is typically rectified by diodes 214, 215 and filtered as required by capacitor 216, component types and values of output filtering characteristics selected to provide the desired degree of filtering of the isolated DC output.

An advantage of this circuit is that is able to use low power high speed solid state switches, making possible the design of compact low power, efficient converters, not possible using previous methods. The use of high frequency solid-state switches reduces considerably the size of the converter when appropriate parts are selected, principally the size of capacitors 207, 208, 209, 210, 211, 212, 216 as well as the transformer 213. It will be obvious to those skilled in the art to recognize that the secondary of transformer 213 may be left as AC and not converted into DC if AC is needed as an output.

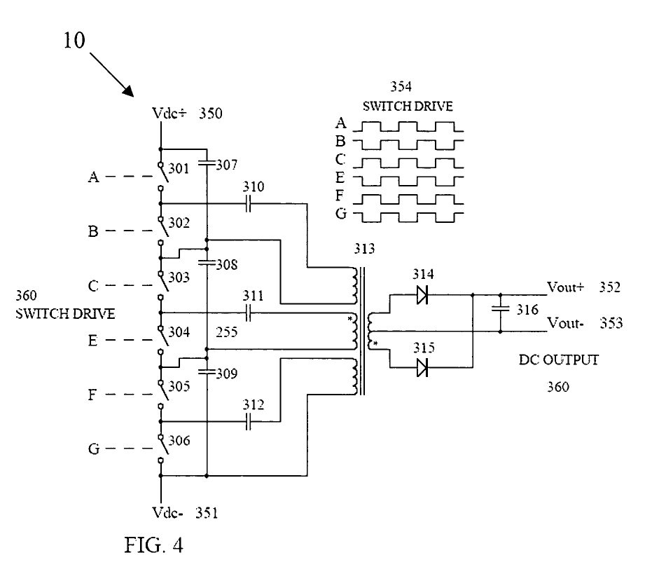

Referring to FIG. 4, a variation of the converter 10, similar to that of FIG. 3 in design and function is shown. In this variation, the output transformer 313 is connected to three half bridges, in this case comprising switches 301, 302; 303, 304; 305, 306. Capacitors 307, 308, 309 filter the switching noise appearing as an AC ripple or transient across the three half bridges. Capacitor 310 connects one primary of the transformer 313 to the half bridge made up of switches 301, 302. Similarly, capacitor 311 connects one primary of the transformer 313 to the half bridge made up of switches 303, 304 and finally capacitor 312 connects one primary of the transformer 313 to the half bridge made up of switches 305, 306. This arrangement uses the same clocking sequence for the switches as the converter in FIG. 3 and the arrangement is shown in the table called TYPICAL SWITCH DRIVE 354. This configuration has advantages as the physical layout of high power converters, as well as the reverse phasing of every other half-bridge group may under some circumstances reduce an AC ripple that appears across Vdc+350 and Vdc−351 as well as reducing any radiated noise (EMI) from the converter. The secondary of the transformer 313 may be rectified by diodes 314, 315 and filtered as required by capacitor 316 into a filtered isolated DC output. It will be obvious to those skilled in the art to recognize that the secondary of Transformer 313 may be left as AC and not converted into DC if the AC is desired.

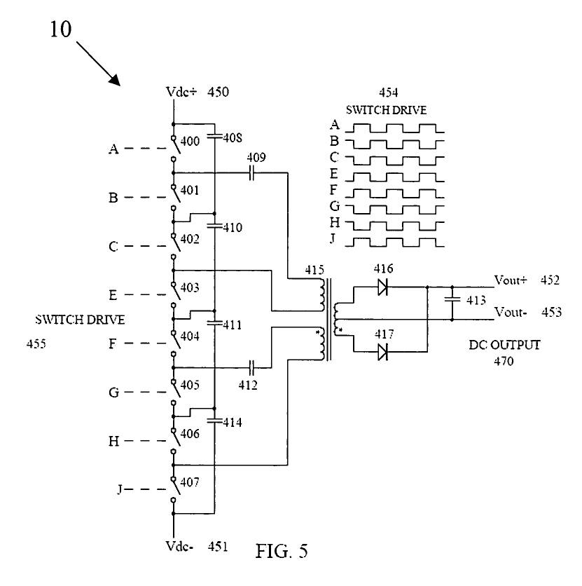

Referring to FIG. 5, another variation of the converter 10, similar to that of FIGS. 3 and 4 in design and function is shown. In this variation, the output transformer 415 is connected to four half bridges comprising switches 400, 401; 402, 403; 404, 405; 406, 407. Capacitor 408, 410, 411, 414 filter the DC across the four half bridges. Capacitor 409 connects one primary of transformer 415 to the half bridge made up of switch 400, 401 to a reverse phased half bridge made up of switches 402, 403. Similarly, capacitor 412 connects another primary of transformer 415 to the half bridge made up of switches 404, 405 to a reversed phased half bridge made up of switches 406, 407. This arrangement has a different clocking sequence for the switches than in FIGS. 3 or 4 and the new arrangement is shown in the table called SWITCH DRIVE 454.

This configuration has advantages for the design of the physical layout of high power converters as the half bridges are configured as full bridges. The use of this configuration and different phased switch drive signals group can be used to reduce an AC ripple that appears across Vdc+450 and Vdc−451 as well as reduce any radiated noise created by the converter. The secondary of transformer 415 may be rectified by diodes 416, 417 and filtered as required by capacitor 413 into a filtered isolated DC output. It will be obvious to those skilled in the art to recognize that the secondary of Transformer 415 may be left as AC and not converted into DC if the AC is needed for another purpose.

To those skilled in the art it is obvious that other combinations and permutations of switch arrangement than the examples in FIG. 3, FIG. 4 and FIG. 5 are possible.

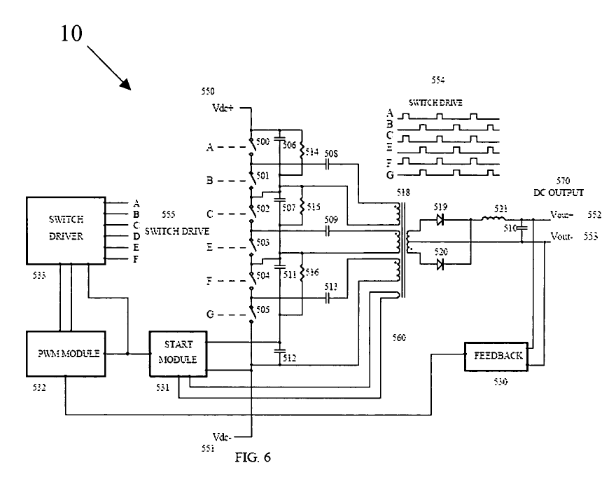

Referring generally to FIG. 6, a variation of the converter 10 of the present invention is shown having a regulated output achieved by a feedback system. A PWM (Pulse Width Modulation) SWITCH DRIVE 554 may be PWM controlled in a similar manner as used by commercial AC to DC switching power supplies. Switches 500, 501; 502, 503, 504, 505 form three half bridges that are connected in series in a similar manner to FIG. 3, FIG. 4 and FIG. 5. Capacitors 506, 507, 511, 512 filter the switch current pulses reducing the AC that is generated by the half bridges across the high voltage DC input Vdc+550 and Vdc−551. The addition of resistors 514, 515 and 516 are used to force the voltages to be equal across capacitors 506, 507 and 511 during the start-up time where the half bridges are off. Capacitor 512 is used to provide start-up power for the START MODULE 531 which has various components that store sufficient charge to run the half bridges for a specific time after which an auxiliary winding 560 from transformer 518 supplies the necessary power to run the control electronics. Alternately, an external DC or AC power source, not shown, may provide power to operate the converter, and may be either common to or close to either Vdc+550 or Vdc−551.

The FEEDBACK 530 supplies an error signal used by the PWM MODULE 532 to generate appropriate width clock signals that are supplied to the SWITCH DRIVER 533, which then drives the switches 500, 501, 502, 503, 504, 505. The additional circuits function as follows. When high voltage power is first applied to Vdc+550 and Vdc−551, the resistors 514, 515 and 516 charge capacitor 512. The START MODULE 531 determines when it has enough charge to operate the PWM MODULE 532 and SWITCH DRIVER 533 for a predetermined time. Alternately, the START MODULE 531 may be powered by an external low voltage DC or AC source. After initially powering the converter electronics, the START MODULE 531 receives a low voltage AC from transformer 518 through secondary 560. The power from this secondary 560 then provides the low voltage power to sustain operation of the PWM MODULE 532 and SWITCH DRIVER 533.

After the START MODULE 531 has started the converter the FEEDBACK 530 provides to the PWM MODULE 532, a signal, which is representative of the output voltage (for example being proportional in some manner to the output voltage).

The FEEDBACK 530 may use optical isolation, an isolation transformer etc., not shown, to provide an isolated feedback signal to the PWM MODULE 532. This feedback mechanism will be obvious known to one skilled in the art, and is similar to that used in traditional power supplies except that the isolation voltage rating is substantially greater. When the SWITCH DRIVE 554 is decreased from full duty (50% of full duty is shown as an example) then the waveform that appears on the secondary of transformer 518 is not a full duty square wave but has positive and negative phases which are proportional in width to the SWITCH DRIVE 554 wave form. The Diodes 519, 520 rectify the secondary AC into a pulsating DC, which is then filtered by inductor 521 and capacitor 510. The output inductor 521 and capacitor 510 filters the pulsating DC into an average value equal to the duty of the waveform times its amplitude. This portion of the circuit will be obvious to one skilled in the art, and may be used, for example in a switching power supply commonly called a FORWARD CONVERTER, except that in the present invention, it provides a regulated low DC voltage output from a very High voltage input.

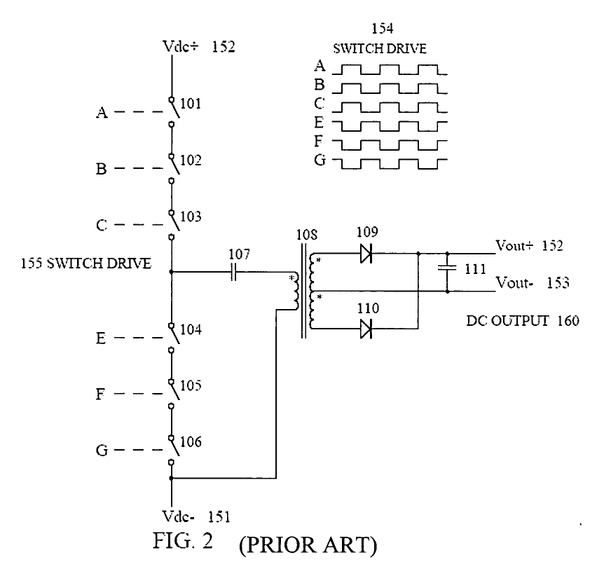

The switches, 500, 501, 502, 503, 504, 505 are typically semi-conductor devices that have a reverse diode across them to clamp any reverse voltage that may be generated by transformer 518 during the time the SWITCH DRIVE 554 changes state. The combination of the switches 500, 501, 502, 503, 504, 500 capacitor 508, 509, 513 and primary of transformer 518 may be combined in any way shown in FIG. 3, FIG. 4 or FIG. 5 or combination of FIG. 2, FIG. 3, FIG. 4 or FIG. 5, implied thereby.

As used herein, the term high voltage DC refers generally to voltages greater than the intended high range tolerance voltage of a single semi-conductor switch used in the intended application. For medium power applications, an exemplary lower limit of a range of high voltages might be 800 V DC.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A high voltage DC to low voltage converter comprising a plurality of switches adapted to connect in series to a high voltage DC source, the switches operated in pairs as half bridges, each half bridge coupled through a plurality of capacitors to a primary of a transformer having an isolated secondary, which is rectified and filtered into low voltage power.

2. The high voltage DC to low voltage converter as in claim 1, wherein the plurality of switches are paired, each pair of switches forming a half bridge and coupled through a capacitor to separate primaries of an isolation transformer with one or more secondaries rectified and filtered into a low voltage DC supply.

3. The high voltage DC to low voltage converter as in claim 1, wherein the plurality of switches are paired, coupled through a capacitor to one side of a primary of an isolation transformer, and the other side of the primary coupled to another half bridge switch pair which is operated in opposite phase to the half bridge on the opposite side of the primary, thus forming a full bridge, of which there are one or more each with separate primaries of an isolation transformer with one or more isolated secondaries rectified and filtered into a low voltage supply.

4. The high voltage DC to low voltage converter as in claim 1, where the plurality of switches are paired, each pair of switches forms a half bridge and is coupled through a capacitor to a common primary of a transformer which has one or more isolated secondaries rectified by diodes forming a rectified pulsing DC supply which is then filtered by an inductor and capacitor in to a low voltage DC supply which is substantially equal to the average of the pulsating DC input, and a control circuit that provides a feedback signal to a PWM MODULE that generates a pulse width modulated signal in relation to the feedback provided to a SWITCH DRIVER that turns the switches on and off with a time period governed by the PWM signal, and control electronics adapted to be powered by a START MODULE powered temporarily at starting by a start-up capacitor and after starting by an isolated secondary of the transformer.

5. The high voltage DC to low voltage converter as in claim 4, wherein the START MODULE is powered by an external DC power source.

6. The high voltage DC to low voltage converter as in claim 4, wherein the START MODULE is powered by an external AC power source.

7. The high voltage DC to low voltage converter as in claim 4, wherein the START MODULE is powered by an external DC power source provided by a low voltage, isolated, DC to DC half bridge.

8. The high voltage DC to low voltage converter as in claim 5, wherein the START MODULE is powered by an external DC power source provided by a low voltage, isolated, AC to DC half bridge.

9. The high voltage DC to low voltage converter as in claim 4, wherein each half bridge is coupled through a capacitor to separate primaries of an isolation transformer.

10. The high voltage DC to low voltage converter as in claim 4, where each half bridge is coupled through a capacitor to one side of a primary of an isolation transformer and the other side of the primary is coupled through a capacitor to another half bridge switch pair operated in opposite phase to the half bridge on the opposite side of the primary, all forming a full bridge, with one or more full bridges in series, operated with each coupled and appropriately phased to a common primary of an isolation transformer.

11. The high voltage DC to low voltage converter as in claim 1, wherein the SWITCH DRIVE may be turned OFF and ON by an external control signal.

12. The high voltage DC to low voltage converter as in claim 1, which operates from a common high voltage distribution bus and is enabled on demand to convert available high voltage DC to low voltage power to operate a low voltage device.

13. The high voltage DC to low voltage converter as in claim 1, adapted to operate a solid state RF amplifier to replace a high voltage vacuum RF amplifying device.

14. The high voltage DC to low voltage converter as in claim 1, adapted to operate an electric motor.

15. The high voltage DC to low voltage converter as in claim 14, wherein the electric motor is adapted to operate in a vehicle.

16. The high voltage DC to low voltage converter as in claim 1, adapted to convert the output of a high voltage battery to low voltage electricity upon demand.

17. The high voltage DC to low voltage converter as in claim 1, where the high voltage DC to low voltage converter is adapted to operate, on demand, a solid state laser module or subcomponents of a large solid state laser array.

18. The high voltage DC to low voltage converter as in claim 1, adapted to operate a solid state RF amplifier as a replacement for a high voltage vacuum tube-type RF amplifying device.

19. The high voltage DC to low voltage converter as in claim 1, adapted to operate an electric motor in a vehicle.

20. The high voltage DC to low voltage converter as in claim 1, adapted to convert the output of a high voltage battery to a low voltage power upon demand.

21. The high voltage DC to low voltage converter as in claim 4, wherein the SWITCH DRIVE is powered by the START MODULE.

22. The high voltage DC to low voltage converter as in claim 5, wherein the SWITCH DRIVE is powered by the START MODULE.

23. The high voltage DC to low voltage converter as in claim 6, wherein the SWITCH DRIVE is powered by the START MODULE.

24. The high voltage DC to low voltage converter as in claim 7, wherein the SWITCH DRIVE is powered by the START MODULE.

25. The high voltage DC to low voltage converter as in claim 8, wherein the SWITCH DRIVE is powered by the START MODULE.
